(19) United States
(12) Patent Application Publication
(10) Pub. No.: US 2007/0125800 A1
(43) Pub. Date: Jun. 7, 2007

(54) Apparatus for dispensing measured batches of liquid

(76) Inventor: Kevin John Beaumont, West Yorkshire (GB)

Correspondence Address: KING & SCHICKLI, PLLC, 247 NORTH BROADWAY, LEXINGTON, KY, 40507, US

(21) Appl. No.: 10/579,516

(22) PCT Filed: Nov. 15, 2004
(86) PCT No.: PCT/GB04/04818

§ 371 Date: May 16, 2006

(30) Foreign Application Priority Data
Nov. 18, 2003 (GB) 0326726.7

(51) Int. Cl. B67D 5/08

(52) U.S. Cl. 222/64; 222/63

(57) ABSTRACT

Apparatus for dispensing measured batches of liquid have hitherto employed metering pumps which can dispense accurately but are difficult to clean due to their complexity, or analogue meters which cannot dispense small quantities accurately due to their slow response. Apparatus which can dispense batches of any quantity with great precision and is easy to clean comprises a tank (30) containing liquid at a substantially constant pressure for supply to a batch dispensing on/off valve (44) by way of a digital mass flow meter (42), and a computer (48) for controlling the valve in accordance with a soft-ware programme and with information received from the meter. The tank is pressurised by the controlled supply or release of gas through a valve (36). The computer interacts with the valve (44) and the meter (42) by way of electro-pneumatic interfaces (50).

This invention relates to apparatus for dispensing measured batches of liquid. One example of its uses is the filling of cans of paint.

Various arrangements are known for dispensing measured amounts of liquids. One such arrangement employs a metering pump comprising a cylinder containing a reciprocating piston and associated valves and conduits for selectively enabling a supply of liquid to communicate with a specific one, or both, ends of the cylinder and for enabling measured amounts of the liquid to be dispensed only from the other end of the cylinder. This arrangement generally performs accurately and effectively but has the disadvantages that it involves a high level of maintenance; that difficult time consuming cleaning of the rather complex pump is required; that cleaning consequently tends to allow the escape of volatile and possibly dangerous polluting substances which may be contained in the liquid; and that gases in the liquid lead to inaccuracies.

Another such arrangement employs a mass flow meter of analogue or of analogue-to-digital type, but this arrangement has the disadvantage that it is not accurate for small quantities, say less than 10 kilogrammes, of liquid.

A further such arrangement comprises a so-called gravimetric filling machine having a dispensing valve disposed over a container placed on a weigh-scale. This arrangement has the disadvantage that to achieve accuracy, filling must be slow, that is to say accuracy is inversely proportional to the speed of filling.

The object of the present invention is to avoid these disadvantages.

According to the invention, apparatus for dispensing measured batches of liquid comprises means for supplying liquid under pressure to a batch dispensing valve by way of a digital mass flow meter, and computer means for controlling the valve in accordance with a soft-ware programme and with information received from the meter Preferably, the liquid supply means. include a pressurised tank.

Preferably, also, a liquid feed maintains the level of liquid in the tank between pre-set limits, and the pressure in the tank is maintained substantially constant by means for supplying gas under pressure to the tank or releasing gas therefrom in order to compensate for pressure variations therein caused by differences in said level.

Alternative liquid supply means include a flow control valve which is disposed immediately upstream of the meter and is also controlled by the computer means.

Said alternative liquid supply means may include a pump with a pulsating output, and a pulsation damper disposed immediately downstream of the pump.

Said alternative liquid supply means may instead include a pump with a smooth output.

The computer means preferably interact with other components of said apparatus by way of electro-pneumatic interface means.

The invention will now be described in greater detail, by way of example only, with reference to the accompanying drawings, of which:

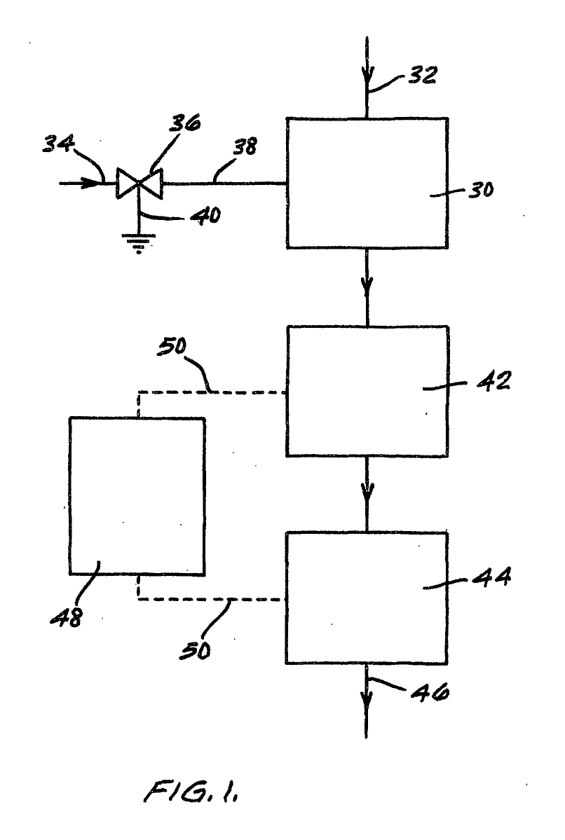

FIG. 1 is a block diagram of a preferred embodiment of apparatus for dispensing measured batches of liquid; and

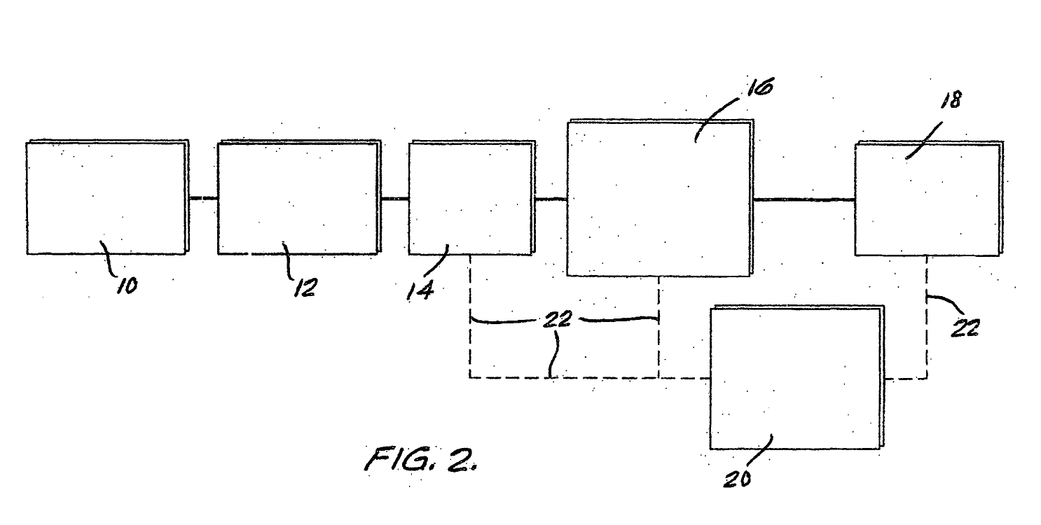

FIG. 2 is a block diagram of an alternative embodiment of such apparatus.

Referring now to FIG. 1 of the drawings, the preferred apparatus includes means for supplying liquid such as paint under pressure comprising a pressurised tank 30. A liquid feed 32 from a bulk container (not shown) is so controlled by a conventional level sensor (not shown) in the tank 30 as to maintain the level of liquid in said tank between pre-set upper and lower limits, and the pressure in the tank 30 is maintained substantially constant by means for supplying a suitable non-reactive and non-toxic gas, usually air, under pressure to said tank or releasing the gas therefrom in order to compensate for pressure variations therein caused by differences in said level. Said means comprise a conduit 34 supplying pressurised gas to a valve 36 which is so controlled by a fast-acting precision pressure regulator (not shown) as to allow the gas to pass into said tank through a conduit 38 or to shut off the conduit 34 and allow gas to escape out of said tank through the conduit 38 and an exhaust port 40. The liquid is arranged to flow from the tank 30 through a digital mass flow meter 42 which is known per se to a batch dispensing on/off valve 44 with an outlet 46. The tank 30, the meter 42 and the valve 44 are conveniently though not necessarily interconnected vertically as illustrated. The apparatus also includes computer means 48 (which expression is herein intended to include a soft-ware programmed logic controller, personal computer, or the like) for controlling the batch dispensing valve 44 in accordance with the soft-ware programme and with information received from the meter 42. To this end the computer means 48 interact with the valve 44 and the meter 42 by way of electro-pneumatic interface means indicated diagrammatically at 50. As there is an inherent time-lag in the operation of the apparatus, the soft-ware programme determines the actual fill quantity as the mass measured by the meter 42 plus a time-lag factor. In comparison with an analogue meter, the digital meter 42 has the advantage of far more rapid and accurate response to changes in flow, thus enabling it to dispense small as well as large quantities of liquid with great precision. The digital meter 42 has the further advantage over an analogue meter of so-called two-phase operation, which enables it to disregard any gas in the liquid and to measure only the mass of the latter.

Referring now to FIG. 2 of the drawings, an alternative apparatus includes means for supplying liquid under pressure comprising a double-diaphragm pump 10 with a pulsating output which draws liquid such as paint from a bulk container (not shown) and delivers it by way of a pulsation damper 12 to a flow control valve 14. The liquid is then passed through a digital mass flow meter 16 which is known per se to a batch dispensing on/off valve 18 with an outlet (not shown). A manually operated on/off valve (not shown) can optionally be interposed between the pulsation damper 12 and the flow control valve 14. The valve 14 is adapted to be held closed to withstand pressure applied to its inlet side by the pump 10 when the apparatus is temporarily not dispensing, and to open relatively gradually at the commencement of the dispensation of each batch of liquid to moderate the initial rate of flow. The apparatus also includes computer means 20 as hereinbefore defined for controlling the flow control valve 14 in accordance with a soft-ware programme and for controlling the batch dispensing valve 18 in accordance with said programme and with information received from the meter 16. To this end the computer means 20 interact with the valves 14 and 18 and the meter 16 by way of electro-pneumatic interface means indicated diagrammatically at 22. As in the preferred apparatus shown in FIG. 1, there is a time-lag in the operation of the apparatus, and the soft-ware programme determines the actual fill quantity as the mass measured by the meter plus a time-lag factor.

In operation, each apparatus hereinbefore described can dispense large or small batches of liquid with great precision. Cleaning when a change of liquid is called for, by appropriate flushing, is simple and can readily be arranged to be non-polluting as there is only a single route through the apparatus including the digital meter 42 or 16. In the preferred apparatus shown in FIG. 1, cleaning is very simply and effectively achieved by placing a so-called spray-ball in the tank 30 and then allowing the apparatus to drain through the outlet 46 by virtue of the vertical interconnection of the tank 30, the meter 42 and the valve 44.

In a modification of the alternative apparatus shown in FIG. 2, any other suitable kind of pump can be employed, such as a gear-type pump with a virtually smooth (which word is herein intended to mean non-pulsating) output. In this case, the pulsation damper can be dispensed with; and furthermore the flow control valve can be dispensed with if desired, especially where such a pump is arranged to start up with a relatively gradually increasing flow at the commencement of the dispensation of each batch of liquid.

1. Apparatus for dispensing measured batches of liquid comprising means for supplying liquid under pressure to a batch dispensing valve by way of a digital mass flow meter, and computer means for controlling the valve in accordance with a soft-ware programme and with information received from the meter.

2. Apparatus according to claim 1, wherein the liquid supply means include a pressurised tank.

3. Apparatus according to claim 2, wherein a liquid feed maintains the level of liquid in the tank between pre-set limits, and the pressure in the tank is maintained substantially constant by means for supplying gas under pressure to the tank or releasing gas therefrom in order to compensate for pressure variations therein caused by differences in said level.

4. Apparatus according to claim 1, wherein the liquid supply means include a flow control valve which is disposed immediately upstream ofthe meter and is also controlled by the computer means.

5. Apparatus according to claim 4, wherein the liquid supply means include a pump with a pulsating output, and a pulsation damper disposed immediately downstream of the pump.

6. (canceled)

7. Apparatus according to claim 1, wherein the computer means interact with other components of said apparatus by way of electro-pneumatic interface means.

8. (canceled)

9. (canceled)

10. Apparatus according to claim 1, wherein the liquid supply means include a pump with a smooth output.

11. Apparatus according to claim 4, wherein the liquid supply means include a pump with a smooth output.
